(19) United States
(12) Patent Application Publication
(10) Pub. No.: US 2022/0100815 A1
(43) Pub. Date: Mar. 31, 2022

(54) METHOD OF REALIZING ACCELERATED PARALLEL JACOBI COMPUTING FOR FPGA

(71) Applicant: ZHEJIANG UNIVERSITY, Zhejiang (CN)

(72) Inventors: Jiming CHEN, Zhejiang (CN); Zhiguo SHI, Zhejiang (CN); Junfeng WU, Zhejiang (CN); Qianwen HE, Zhejiang (CN); Ying LIU, Zhejiang (CN); Youxian SUN, Zhejiang (CN)

(73) Assignee: ZHEJIANG UNIVERSITY, Zhejiang (CN)

(21) Appl. No.: 17/420,682

(22) PCT Filed: Apr. 19, 2019
(86) PCT No.: PCT/CN2019/083494

§ 371 Date: Jul. 5, 2021

(30) Foreign Application Priority Data
Apr. 10, 2019 (CN) 201910285351.4

(51) Int. Cl. G06F 17/16; G06F 7/48; G06F 9/38; G06F 9/30

(52) U.S. Cl. CPC G06F 17/16; G06F 9/30014; G06F 9/3885; G06F 7/4818

(57) ABSTRACT

The invention discloses a method of realizing accelerated parallel Jacobi computing for an FPGA. Data of a n×n-dimensional matrix are input to the FPGA, and a rotation transformation process is carried out by using parallel Jacobi computing. Processors are initialized. A diagonal processor computes a symbol set corresponding to a rotation angle and outputs the symbol set to a non-diagonal processor. Elements of the diagonal processor are updated. Elements of the non-diagonal processor are updated. Elements between the processors are exchanged. After the elements of the respective processors are updated, the updated elements between the processors are exchanged. The invention requires less FPGA resources while yields a higher internal computational processing performance of the FPGA. Accordingly, the invention is capable of facilitating the efficiency of realizing eigenvalue decomposition in the FPGA and is highly applicable in actual processing.

### BACKGROUND OF THE INVENTION

### 1. Field of the Invention

The invention relates to an internal data processing method for an FPGA, and particularly relates to a method of realizing accelerated parallel Jacobi computing for an FPGA.

### 2. Description of Related Art

Many algorithms in various fields, such as radars, wireless communication, image processing, etc., need to compute the eigenvalues of a matrix. For example, the computation of eigenvalues is a key step in sub-space-based direction-of-arrival (DOA) estimation algorithms and principle component analysis (PCA) algorithms.

Currently, algorithms for computing a large number of eigenvalues include, for example, QR algorithms, LU decomposition algorithms, algebraic methods, etc. Since the complexity of root extraction in algebraic methods increases as the dimensions of the matrix increase, algebraic methods are not suitable for obtaining eigenvalues from a large-scale matrix. Meanwhile, LU decomposition algorithms are only suitable for obtaining eigenvalues from an invertible matrix. Besides, while QR algorithms have been proven as faster than serial Jacobi computing in the computation for eigenvalues, studies have nonetheless shown that Jacobi computing exhibits a higher accuracy than that of QR algorithms. Jacobi computing refers to a process of gradually converting a matrix into a nearly-diagonal matrix through a series of rotations. The diagonal elements in the matrix are the eigenvalues of the matrix. In addition, owing to the inherent parallelism of Jacobi computing resulting from its decomposition of eigenvalues from a real symmetric matrix, parallel Jacobi computing (a parallel method for realizing Jacobi computing) has been broadly applied for eigenvalue decomposition in FPGA-related applications.

Currently, some studies have been undertaken in hope to accelerate parallel Jacobi computing. However, most of these acceleration methods are unable to realize one step of parallel Jacobi computing in one CORDIC algorithm cycle. While the conventional approximate Jacobi computing is capable of realizing one step of parallel Jacobi computing in one CORDIC algorithm cycle, the performance is not entirely satisfactory. This is because the rotations are approximate rotations, which increase the total number of rotations required. Besides, while the total lookup table (LUT) resources in an FPGA are limited, the consumption of the LUT resources in the FPGA is not considered when the conventional algorithms are put into practice.

### SUMMARY OF THE INVENTION

To address the above issues, the invention proposes a method of realizing accelerated parallel Jacobi computing for an FPGA and designs a solution which brings forth favorable computation processing efficacies when the parallel Jacobi computing method is realized in the FPGA. With the method, the technical issues that internal data processing in an FPGA is slow and resource-consuming are addressed, and the objective of realizing one step of parallel Jacobi computing within one CORDIC algorithm cycle is achieved. Besides, the resource consumption in the FPGA is reduced.

To achieve the objectives, the invention provides a technical solution with the following steps.

(1) Initializing Processors:

Data of a n×n-dimensional matrix are input into the FPGA and a rotation transformation process using the parallel Jacobi computing is carried out. A coordinate rotation digital computer (CORDIC) algorithm is adopted in Jacobi computing to carry out a planar rotation, and a two-dimensional X-Y coordinate system is established in the planar rotation.

A plurality of processors are provided in a field programmable gate array (FPGA). The processors are arranged in an array. Each of the processors is connected with an adjacent processor via a data interface to exchange data and elements, and each element in the n×n-dimensional matrix for carrying out the parallel Jacobi computing is assigned to a processor Pᵢⱼ according to a formula as follows:

$${P}_{ij} = ( \begin{matrix}{a}_{2 i - 1 , 2 j - 1} & {a}_{2 i - 1 , 2 j} \\ {a}_{2 i , 2 j - 1} & {a}_{2 i , 2 j}\end{matrix} ) , i \leq j , j = 1 , 2 , … , \frac{n}{2} ,$$

wherein Pᵢⱼ represents a processor in an i^{th} row and a j^{th} column, a_{2i,2j} represents an element in a 2i^{th} row and a 2j^{th} column in the n×n-dimensional matrix, and Y represents dimensionality of the matrix.

A processor Pᵢⱼ whose subscripted symbol satisfies i=j is a diagonal processor and a processor Pᵢⱼ whose subscripted symbol does not satisfy i=j is a non-diagonal processor. In the processors Pᵢⱼ, an element whose subscripted symbol satisfies 2i=2j and 2i−1=2j−1 is a diagonal element, and an element whose subscripted symbol does not satisfy 2i=2j and 2i−1=2j−1 is a non-diagonal element.

The n×n-dimensional matrix is a real symmetric matrix. Therefore, with the assignment of the above process, only the upper right portion is preserved, and the lower left portion and the upper right portion are symmetric to each other with respect to the diagonal.

(2) Computing a Symbol Set Corresponding to a Rotation Angle 2θ by the Diagonal Processor and Outputting the Symbol Set to the Non-Diagonal Processor:

A symbol set {d_{2θ,k}}, k=1, 2, . . . , N which corresponds to a rotation angle 2θ of the CORDIC algorithm, is obtained through iterations by using a formula as follows. A total number of the iterations is the same as a total number of iterations of the CORDIC algorithm:

$$tan ( {θ}_{k} ) = \frac{{α}_{k}}{{β}_{k}} = tan ( {θ}_{k - 1} - {d}_{2 θ , k} {ϕ}_{k - 1} ) = \frac{tan {θ}_{k - 1} - {d}_{θ , k} tan {ϕ}_{k - 1}}{1 + {d}_{θ , k} tan {θ}_{k - 1} tan {ϕ}_{k - 1}} = \frac{{α}_{k - 1} {2}^{k - 1} - {d}_{θ , k} {β}_{k - 1}}{{β}_{k - 1} {2}^{k - 1} + {d}_{θ , k} {α}_{k - 1}} , \\ {d}_{2 θ , k} = \{ \begin{matrix}- 1 , \frac{{α}_{k - 1}}{{β}_{k - 1}} < 0 \\ 1 , \frac{{α}_{k - 1}}{{β}_{k - 1}} \geq 0\end{matrix} , {θ}_{0} = 2 θ , tan ( {ϕ}_{k - 1} ) = {2}^{- ( k - 1 )} , k = 1 , 2 , … , N ,$$

wherein k represents an ordinal number of an iteration, N represents the total number of the iterations and is set as a data bit number adopted by the FPGA, αₖ represents a first symbol parameter of a k^{th} iteration, βₖ represents a second symbol parameter of the k^{th} iteration, θ₀ represents a rotation angle initial value, that is, 2θ, θₖ represents a residual rotation angle through k times of iterations, ϕₖ₋₁ represents an angle parameter of a (k−1)^{th} iteration, and d_{2θ,k} represents a symbol corresponding to the rotation angle 2θ at the k^{th} iteration.

Specifically, in a symbol computing module, d_{2θ,k} is obtained by performing an exclusive OR operation on the sign bits of αₖ₋₁ and βₖ₋₁, where d_{2θ,k} is 1 if the sign bits are the same, and d_{2θ,k} is −1 if the sign bits are opposite. αₖ₋₁2^{k-1} is obtained from αₖ₋₁ through a shift operation, and βₖ₋₁2^{k-1} is obtained from βₖ₋₁ through a shift operation. If d_{2θ,k} is 1, αₖ is obtained by performing a subtract operation on αₖ₋₁2^{k-1} and βₖ₋₁, and βₖ is obtained by performing an add operation on βₖ₋₁2^{k-1} and αₖ₋₁. If d_{2θ,k} is −1, αₖ is obtained by performing an add operation on αₖ₋₁2^{k-1} and βₖ₋₁, and βₖ is obtained by performing a subtract operation on βₖ₋₁2^{k-1} and αₖ₋₁.

Iterative computing starts, and an initial rotation angle corresponding to the non-diagonal elements in the diagonal processor is θ. The computation is as follows:

$$tan ( 2 θ ) = \frac{{α}_{0}}{{β}_{0}} ,$$

a₀=2a_{pq}, β₀=aₚₚ−a_{qq},
wherein a_{pq}, a_{qp} respectively represent two non-diagonal elements initially included in the diagonal processor, a_{qp}=a_{pq}, aₚₚ, and aₚₚ respectively represent diagonal elements initially included in the diagonal processor, α₀ represents an initial first symbol parameter, and β₀ represents an initial second symbol parameter.

The diagonal elements aₚₚ and a_{qq} of the diagonal processor obtain β₀=aₚₚ−a_{qq} through a subtract operation. The non-diagonal element a_{pq} obtains α₀=2a_{pq} in a shift operation. It is set that, in the parallel Jacobi computing, the rotation angle corresponding to the non-diagonal element in the current diagonal processor is θ, and β₀ and α₀ are input, as initial values, into a symbol set computing module, and the symbol computing module obtains a symbol set {d_{2θ,k}} corresponding to the rotation angle 2θ through iterations.

The diagonal processor outputs the rotation angle 2θ obtained through computing carried out by itself and and the corresponding symbol set {d_{2θ,k}} to a non-diagonal processor on the same row and a non-diagonal processor on the same column.

(3) Updating Elements of the Diagonal Processor:

The CORDIC algorithm is carried out on first to-be-rotated coordinates (2a_{pq},aₚₚ−a_{qq}) by using d_{2θ,k} obtained in each of the iterations in Step (2) as a rotation symbol of the k^{th} iteration in the CORDIC algorithm. This process replaces the step of calculating a rotation symbol after each iteration in the conventional CORDIC algorithm. Accordingly, a planar rotation is carried out by using the rotation angle 2θ.

After all the iterations in Step (2) are completed, a final planar rotation result is multiplied by a first compensation factor to obtain rotated y coordinates, that is, y₁=2a_{pq} sin 2θ+(aₚₚ−a_{qq})cos 2θ. The first compensation factor is obtained according to a formula as follows:

$${C}_{1} = {\prod }_{k = 1}^{N} cos ( {ϕ}_{k - 1} ) ,$$

wherein C₁ represents the first compensation factor.

Diagonal elements in the diagonal processor are updated by using a formula as follows, and non-diagonal elements are set to 0:

$${a}_{pp}^{′} = \frac{{a}_{qq} + {a}_{pp} + {y}_{1}}{2} , \\ {a}_{qq}^{′} = \frac{{a}_{qq} + {a}_{pp} - {y}_{1}}{2} ,$$

wherein a′ₚₚ, a′_{qq} represent two updated diagonal elements in the diagonal processor, y₁ represents a rotated Y-axis coordinate of the first to-be-rotated coordinates.

(4) Updating Elements of the Non-Diagonal Processor:

(4.1) The non-diagonal processor Pᵢⱼ receives symbol sets output from two diagonal processors Pᵢᵢ, Pⱼⱼ and represented as {d_{2θ}_{ᵢ}_{,k}}, {d_{2θ}_{ⱼ}_{,k}}. d_{2θ}_{ᵢ}_{,k} and d_{2θ}_{ⱼ}_{,k} respectively represent symbols corresponding to a rotation angle 2θ₁ and a rotation angle 2θⱼ at the k^{th} iteration, and two symbols d_{θ}_{ᵢ}_{+θ}_{ⱼ}_{,k} and d_{θ}_{ᵢ}_{-θ}_{ⱼ}_{,k} are respectively computed by using formulae as follows to obtain two symbol sets {d_{θ}_{ᵢ}_{+θ}_{ⱼ}_{,k}} and {d_{θ}_{ᵢ}_{-θ}_{ⱼ}_{,k}}:

d_{θ}_{ᵢ}_{+θ}_{ⱼ}_{,k}=½(d_{2θ}_{ᵢ}_{,k}+d_{2θ}_{ⱼ}_{,k}), k=1,2, . . . ,N,

d_{θ}_{ᵢ}_{-θ}_{ⱼ}_{,k}=½(d_{2θ}_{ᵢ}_{,k}−d_{2θ}_{ⱼ}_{,k}), k=1,2, . . . ,N,

wherein d_{θ}_{ᵢ}_{+θ}_{ⱼ}_{,k} and d_{θ}_{ᵢ}_{-θ}_{ⱼ}_{,k} respectively represent symbols corresponding to a rotation angle θᵢ+θⱼ and a rotation angle θᵢ−θⱼ, and 2θ₁ and 2θⱼ respectively represent double angles of rotation angles corresponding to the non-diagonal elements of the two diagonal processors Pᵢᵢ and Pⱼⱼ.

Specifically, by subjecting each pair of symbols d_{2θ}_{ᵢ}_{,k}, d_{2θ}_{ⱼ}_{,k} to an exclusive OR and a data selector, the symbol set for the rotation angle θₗ-θₘ is determined. If the result of the exclusive OR operation is 1, d_{2θ}_{ₗ}_{,k} is taken as d_{θ}_{ₗ}_{-θ}_{ₘ}_{,k}, otherwise 0 is taken as d_{θ}_{ₗ}_{-θ}_{ₘ}_{,k}. By subjecting each pair of symbols d_{2θ}_{ₗ}_{,k}, d_{2θ}_{ⱼ}_{,k} to an exclusive NOR and a data selector, the symbol set for the rotation angle θₗ+θₘ is determined. If the result of the exclusive NOR operation is 1, d_{2θ}_{ₗ}_{,k} is taken as d_{θ}_{ₗ}_{+θ}_{ₘ}_{,k}, otherwise 0 is taken as d_{θ}_{ₗ}_{+θ}_{ₘ}_{,k}.

(4.2) d_{θ}_{ᵢ}_{±θ}_{ⱼ}_{,k} has three values, i.e., {−1,0,1}. Values of a second compensation factor and a third compensation factor corresponding to all possible symbol combinations formed by first

$$⌈ \frac{N}{2} ⌉$$

symbols in the two symbol sets {d_{θ}_{ᵢ}_{+θ}_{ⱼ}_{,k}} and {d_{θ}_{ᵢ}_{-θ}_{ⱼ}_{,k}} are computed by using formulae as follows, one symbol combination being formed by

$$⌈ \frac{N}{2} ⌉$$

symbols, so as to establish lookup table data by using the values of the second compensation factor and the third compensation factor corresponding to the respective, different symbol combinations. The absolute value of each symbol in the first

$$⌈ \frac{N}{2} ⌉$$

symbols serves as a lookup address, and a lookup table is generated by using a block memory (block random access memory). An address bit number of the lookup table is set as

$$⌈ \frac{N}{2} ⌉ ,$$

and a data depth is

$${2}^{⌈ \frac{N}{2} ⌉} ;$$

$${C}_{2} = {Π}^{{⌈ \frac{N}{2} ⌉}^{k = 1}} cos ( {d}_{{θ}_{i} - {θ}_{j} , k} {ϕ}_{k - 1} ) , {d}_{{θ}_{i} - {θ}_{j} , k} ∈ \{ - 1 , 0 , 1 \} , \\ {C}_{3} = {Π}^{{⌈ \frac{N}{2} ⌉}^{k = 1}} cos ( {d}_{{θ}_{i} + {θ}_{j} , k} {ϕ}_{k - 1} ) , {d}_{{θ}_{i} + {θ}_{j} , k} ∈ \{ - 1 , 0 , 1 \} ,$$

wherein C₂ represents the second compensation factor, and C₃ represents the third compensation factor.

When the number of iterations of the CRODIC algorithm exceeds

$$⌈ \frac{N}{2} ⌉$$

(rounding up

$$\frac{N}{2} ) ,$$

the difference between the second and third compensation factors and 1 is less than 2^{-N+1}, and the accuracy of N-bit signed fixed-point number is at most 2^{-N+1}. Therefore, the remaining second and third compensation factors may be directly considered as 1, i.e., no compensation is required.

(4.3) For the non-diagonal processor, four elements included in the non-diagonal processor are represented as

$$( \begin{matrix}{a}_{{p}_{1} {q}_{1}} & {a}_{{p}_{1} {q}_{2}} \\ {a}_{{p}_{2} {q}_{1}} & {a}_{{p}_{2} {q}_{2}}\end{matrix} ) .$$

The obtained d_{θ}_{ᵢ}_{-θ}_{ⱼ}_{,k} is used as the rotation symbol of the k^{th} iteration in the CORDIC algorithm, and the CORDIC algorithm is carried out on second to-be-rotated coordinates (aₚ_{₁}_{q}_{₁}+aₚ_{₂}_{q}_{₂},aₚ_{₁}_{q}_{₂}−aₚ_{₂}_{q}_{₁}) to carry outa planar rotation by using the rotation angle θᵢ-θⱼ. A planar rotation result is multiplied by the second compensation factor whose value is obtained by accessing the lookup table of Step (4.2) to obtain rotated coordinates represented as:

$$\{ \begin{matrix}{x}_{2} = ( {a}_{{p}_{1} {q}_{1}} + {a}_{{p}_{2} {q}_{2}} ) cos ( {θ}_{i} - {θ}_{j} ) - ( {a}_{{p}_{1} {q}_{2}} - {a}_{{p}_{2} {q}_{1}} ) sin ( {θ}_{i} - {θ}_{j} ) \\ {y}_{2} = ( {a}_{{p}_{1} {q}_{2}} - {a}_{{p}_{2} {q}_{1}} ) cos ( {θ}_{i} - {θ}_{j} ) + ( {a}_{{p}_{1} {q}_{1}} + {a}_{{p}_{2} {q}_{1}} ) sin ( {θ}_{i} - {θ}_{j} )\end{matrix}$$

wherein x₂ and y₂ respectively represent rotated coordinates of the second to-be-rotated coordinates.

The obtained d_{θ}_{ᵢ}_{+θ}_{ⱼ}_{,k} is used as the rotation symbol of the k^{th} iteration in the CORDIC algorithm. The CORDIC algorithm is carried out on third to-be-rotated coordinates (aₚ_{₁}_{q}_{₂}+aₚ_{₂}_{q}_{₁},aₚ_{₁}_{q}_{₁}−ₚ_{₂}_{q}_{₂}) to carry out a planar rotation by using the rotation angle θᵢ+θⱼ. A planar rotation result is multiplied by the third compensation factor whose value is obtained by accessing the lookup table of Step (4.2) to obtain rotated coordinates represented as:

$$\{ \begin{matrix}{x}_{3} = ( {a}_{{p}_{1} {q}_{2}} + {a}_{{p}_{2} {q}_{1}} ) cos ( {θ}_{i} + {θ}_{j} ) - ( {a}_{{p}_{1} {q}_{1}} - {a}_{{p}_{2} {q}_{2}} ) sin ( {θ}_{i} + {θ}_{j} ) \\ {y}_{3} = ( {a}_{{p}_{1} {q}_{1}} - {a}_{{p}_{2} {q}_{2}} ) cos ( {θ}_{i} + {θ}_{j} ) + ( {a}_{{p}_{1} {q}_{2}} + {a}_{{p}_{2} {q}_{1}} ) sin ( {θ}_{i} + {θ}_{j} )\end{matrix}$$

wherein x₃ and y₃ respectively represent rotated coordinates of the third to-be-rotated coordinates.

(4.4) Adopting formulae as follows to update the elements in the non-diagonal processor:

a′ₚ_{₁}_{q}_{₁}=½(x₂+y₃),

a′ₚ_{₁}_{q}_{₂}=½(x₃+y₂),

a′ₚ_{₂}_{q}_{₁}=½(x₃−y₂),

a′ₚ_{₂}_{q}_{₂}=½(x₂−y₃),

wherein a′ₚ_{₁}_{q}_{₁}, a′ₚ_{₁}_{q}_{₂}, a′ₚ_{₂}_{q}_{₁}, and a′ₚ_{₂}_{q}_{₂} respectively represent four elements included in the non-diagonal processor.

Specifically, by performing an add operation and a shift operation on x₂ and y₃, an updated value a′ₚ_{₁}_{q}_{₁} as shown in the formula is obtained. By performing an add operation and a shift operation on x₃ and y₂, an updated value a′ₚ_{₁}_{q}_{₂} as shown in the formula is obtained. By performing a subtract operation and a shift operation on x₃ and y₂, an updated value a′ₚ_{₂}_{q}_{₁} as shown in the formula is obtained. By performing a subtract operation and a shift operation on x₂ and y₃, an updated value a′ₚ_{₂}_{q}_{₂} as shown in the formula is obtained.

(5) Exchanging the Elements Between the Processors:

After the elements of the respective processors are updated, the matrix elements symmetric thereto are also updated to the same values. The updated elements between the processors are exchanged.

(5.A) The diagonal elements in the diagonal processor are exchanged.

It is assumed that a current diagonal processor Pᵢᵢ includes a diagonal element aₚ_{ᵢ}ₚ_{ᵢ} and a diagonal element a_{q}_{ᵢ}_{q}_{ᵢ}.

For the diagonal element i represents a diagonal processor row/column ordinal number, if i=1, the diagonal element aₚ_{ᵢ}ₚ_{ᵢ} is not changed, if i=2, a value of the diagonal element aₚ_{ᵢ}ₚ_{ᵢ} is changed to a value of a diagonal element a_{q}_{ᵢ₊₁}_{q}_{ᵢ₊₁}, and if i>2, the value of the diagonal element aₚ_{ᵢ}ₚ_{ᵢ} is changed to a value aₚ_{ᵢ₊₁}ₚ_{ᵢ₊₁} of a diagonal element.

For the diagonal element a_{q}_{ᵢ}_{q}_{ᵢ}, if

$$i < \frac{n}{2} ,$$

a value of the diagonal element a_{q}_{ᵢ}_{q}_{ᵢ} is changed to a value of a_{q}_{ᵢ₊₁}_{q}_{ᵢ₊₁}, and if

$$i = \frac{n}{2} ,$$

the value of the diagonal element a_{q}_{ᵢ}_{q}_{ᵢ} is changed to the value of the diagonal element aₚ_{ᵢ}ₚ_{ᵢ}.

(5.B) The non-diagonal elements in the diagonal processor and elements in the non-diagonal processor are exchanged by changing positions according to the following. Positions of the non-diagonal elements in the diagonal processor and the elements in the non-diagonal processor are shifted. It is noted that the elements may be shifted out of a processor to another processor. Accordingly, a subscripted row symbol of an element is the same as a row number of a diagonal element shifted to the same row after the exchanging of Step (5.A), and a subscripted column symbol of the element is the same as a column number of a diagonal element shifted to the same column after the exchanging of Step (5.A).

(6) Updating the non-diagonal elements in all the diagonal processors in the n×n-dimensional matrix by the Jacobi computing after the exchanging, returning to Step (2) for another round of processing and updating, repeating the updating until the non-diagonal elements in the n×n-dimensional matrix gradually converge to 0, finishing the updating when a predetermined convergence accuracy is met, and ending the parallel Jacobi computing.

The n×n-dimensional matrix is a covariance matrix of data collected by an antenna array or data before image dimensionality reduction, and is a real symmetric matrix.

In Step (1), if n in the n×n-dimensional matrix is an odd number, i.e., a matrix with odd-numbered dimensionality, the matrix is expanded into a matrix with even-number dimensionality by adding a n+1^{th} column and a n+1^{th} row, and element values of the added n+1^{th} column and n+1^{th} row are all set to 0.

In the invention, the k^{th} symbol computed in Step (2) is provided to the CORDIC algorithms of Steps (3) and (4) for the k^{th} iteration. Therefore, Steps (2), (3), and (4) are carried out simultaneously.

The updated values of the elements in the respective processors can be obtained by simply combining the computing results of the CORDIC algorithms. Therefore, operations for the elements of all the processors can be carried out simultaneously. According to the method of the invention, the time consumed for realizing one step of the parallel Jacobi computing is only one CORDIC cycle. Compared with the conventional method which consumes three CORDIC cycles, the computing time is significantly reduced, and the computing performance is facilitated.

The data of the n×n-dimensional matrix of the invention may be data collected by an antenna array for DOA estimation, or a covariance matrix used for reducing the dimensionality of image data by using a PCA algorithm.

The beneficial effects of the invention include the following.

The invention adopts a specifically designed linear combination method to replace the bilateral rotation method in the conventional parallel Jacobi computing. By using the symbol set of the rotation angle together with the combination of two symbol sets to replace the step of computing the rotation symbols in the CORDIC algorithm, the parallelism of the parallel Jacobi computing is facilitated, the computing time for each step in the parallel Jacobi computing is reduced, and one step of the parallel Jacobi computing can be realized in one CORDIC cycle.

The invention effectively facilitates the speed of realizing the parallel Jacobi computing in hardware. By realizing one step of the parallel Jacobi in one CORDIC algorithm cycle, the deficiency of the conventional method is alleviated. In addition, the time required is only one-third of that required by the conventional method.

The invention requires less FPGA resources while yields a higher internal computational processing performance of the FPGA. Accordingly, the invention is capable of facilitating the efficiency of realizing eigenvalue decomposition in the FPGA and is highly applicable in actual processing.

### BRIEF DESCRIPTION OF THE DRAWINGS

FIG. 1 is a schematic diagram illustrating a framework of a diagonal processor according to an embodiment of the invention.

FIG. 2 is a schematic diagram illustrating a framework of a non-diagonal processor according to an embodiment of the invention.

FIG. 3 is a schematic diagram illustrating a framework of a processor array according to an embodiment of the invention.

FIG. 4 is a flowchart illustrating a computing method according to an embodiment of the invention.

### DESCRIPTION OF THE EMBODIMENTS

In the following, details of the invention will be described with reference to the accompanying drawings in combination with exemplary embodiments of the invention.

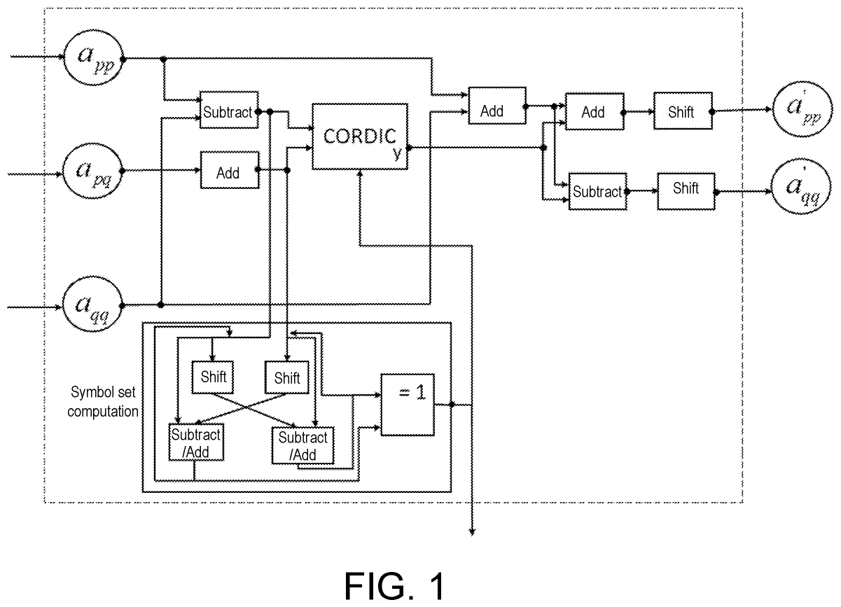

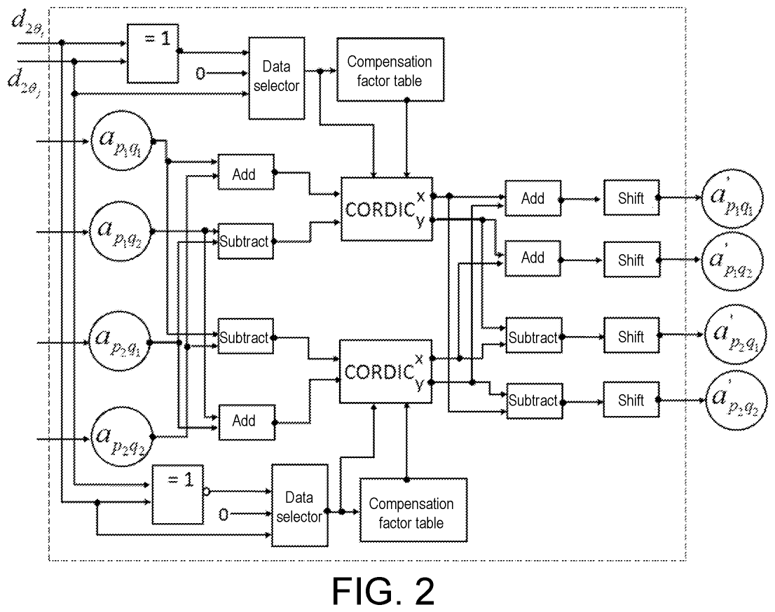

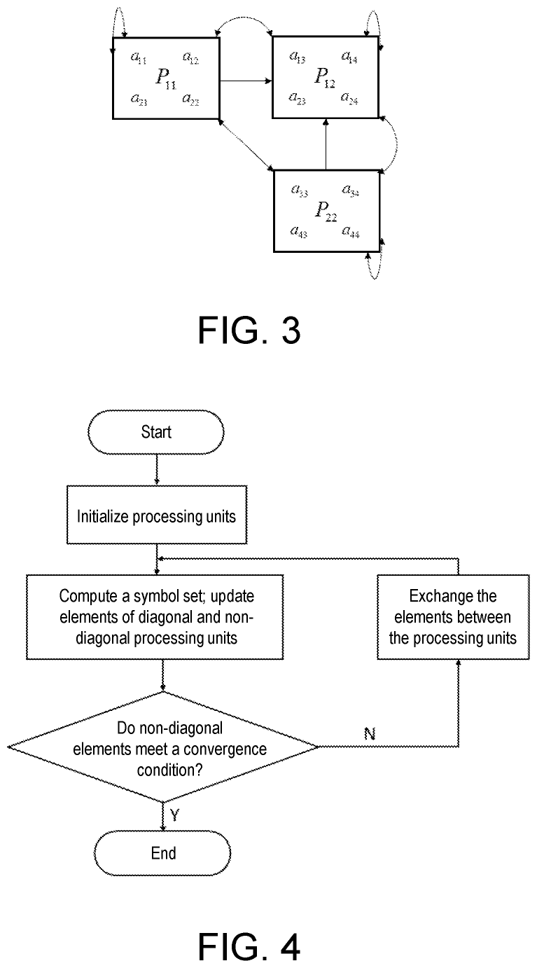

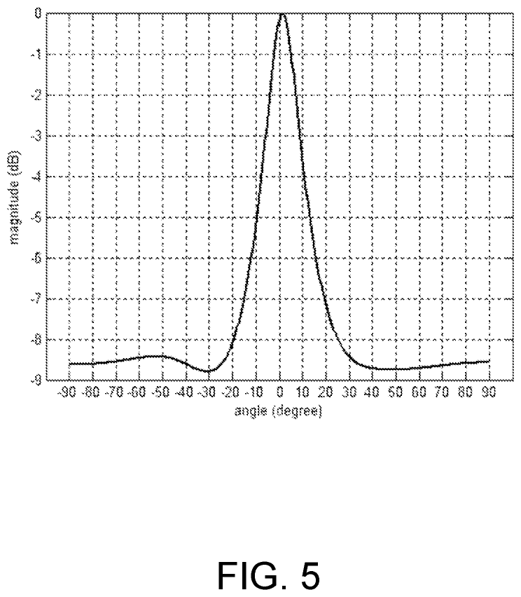

The framework realized in an FPGA of the invention mainly includes a diagonal processor and a non-diagonal processor. The framework of the diagonal processor is as shown in FIG. 1, and the framework of the non-diagonal processor is as shown in FIG. 2. A framework of a processor array is as shown in FIG. 3. A flowchart for executing a computing method is as shown in FIG. 4.

The embodiment of the invention and the implementation process thereof are described in the following.

The specific implementation processes of the embodiment are realized in a Xilinx Virtex-7 XC7VX690T FPGA chip. Specifically, wireless signals emitted by a collector drone with a four-element antenna array is adopted in the implementation, and the signal incident direction is 0 degrees. A 4×4 real symmetric covariance matrix obtained through the computation carried out according to four data sets received by the four-element antenna is represented as A.

16-bit fixed-point number is adopted to obtain the eigenvalues under a condition that

$$A = ( \begin{matrix}237.4904 & 231.6229 & - 104.5409 & 24.3696 \\ 231.6229 & 541.7360 & - 78.0729 & - 10.1869 \\ - 104.5409 & - 78.0729 & 273.6585 & - 34.0290 \\ 24.3696 & - 10.1869 & - 34.0290 & 170.5949\end{matrix} ) .$$

Specifically, the following steps are included.

(1) Initializing the processors: The respective elements in Rᵣ are assigned to the processors Pᵢⱼ. Each processor is connected with the adjacent processor via a data interface. A processor whose subscripted symbol satisfies i=j is defined as a diagonal processor, and a processor whose subscripted symbol does not satisfy such condition is defined as a non-diagonal processor. A matrix element whose subscripted symbol satisfies 2i=2j and 2i−1=2j−1 is defined as a diagonal element, and a matrix element whose subscripted symbol does not satisfy such condition is defined as a non-diagonal element.

(2) Computing a symbol set corresponding a rotation angle by the diagonal processor and outputting the symbol set to the non-diagonal processor: It is assumed that the non-diagonal elements included in the diagonal processor are a_{pq}, a_{qp}, and a_{qp}=a_{pq}. It is assumed that the diagonal elements included in the diagonal processor are aₚₚ and aₚₚ. It is also assumed that α₀=2a_{pq}, β₀=aₚₚ−a_{qq}. It is assumed that the rotation angle corresponding to the non-diagonal element in the current diagonal processor is θ. A symbol set d_{2θ,k}, k=1, 2 . . . , 16, which corresponds to a rotation angle 2θ of the CORDIC algorithm is obtained through iterations. The number of iterations is the same as the number of iterations in the CORDIC algorithm, and the data bit number, i.e., 16, adopted in the current system is used.

(3) Updating the elements of the diagonal processor: A compensation factor is obtained. d_{2θ,k} obtained in Step (2) is used as the rotation symbol of the k^{th} iteration in the CORDIC algorithm. This process replaces the step of computing the rotation symbol after each iteration in the conventional CORDIC algorithm. The CORDIC algorithm is executed to rotate (2a_{pq},aₚₚ−a_{qq}) by 2θ, and the result is multiplied by the compensation factor to obtain rotated y coordinates, i.e., y₁=2a_{pq} sin 2θ+(aₚₚ−a_{qq}) cos 2θ, and the diagonal elements in the diagonal processor are updated. In addition, the non-diagonal elements are set to 0.

(4) Updating the elements of the non-diagonal processor: The non-diagonal processor Pᵢⱼ receives the symbol sets output from the two diagonal processors Pᵢᵢ, Pⱼⱼ, and the symbol sets are represented as d_{2θ}_{ᵢ}_{,k}, d_{2θ}_{ⱼ}_{,k} k=1, 2, . . . , 32. d_{θ}_{ᵢ}_{+θ}_{ⱼ}_{,k} and d_{θ}_{ᵢ}_{-θ}_{ⱼ}_{,k} are respectively computed.

d_{θ}_{ᵢ}_{±θ}_{ⱼ}_{,k} has three values, i.e., {−1,0,1}. The values of the compensation factors corresponding to all the possible value combinations for the first 16 symbols of the symbol set d_{θ}_{ᵢ}_{±θ}_{ⱼ}_{,k} are computed. The values of the compensation factors are used as lookup table data. The absolute values of the respective symbols of the first 16 symbols in the symbol set are used as lookup addresses, and a lookup table is generated by using a block memory. When the number of iterations of the CRODIC algorithm exceeds 8, the difference between the compensation factor and 1 is less than 2⁻⁷, and the accuracy of 8-bit data is at most 2⁻⁷. Therefore, the remaining compensation factors may be directly considered as 1, i.e., no compensation is required. 8 is set as the address bit number of the lookup table, and the data depth is 2⁸. The lookup table of the example is as shown in Table 1.

TABLE 1
Lookup Table for Compensation Value

| Address | Compensation value |
|---|---|
| 0000 0000 | 1 |
| 0000 0001 | 0.99996948 |
| . | . |
| . | . |
| . | . |
| 1111 1111 | 0.60726543 |

It is assumed that the matrix elements included in the current non-diagonal processor are

$$( \begin{matrix}{a}_{{p}_{1} {q}_{1}} & {a}_{{p}_{1} {q}_{2}} \\ {a}_{{p}_{2} {q}_{1}} & {a}_{{p}_{2} {q}_{2}}\end{matrix} ) ,$$

and d_{θ}_{ₗ}_{-θ}_{ₘ}_{,k} is used as the rotation symbol of the k^{th} iteration in the CORDIC algorithm. A CORDIC algorithm rotation θₗ-θₘ is carried out on (aₚ_{₁}_{q}_{₁}+aₚ_{₂}_{q}_{₂},aₚ_{₁}_{q}_{₂}−aₚ_{₂}_{q}_{₁}). A compensation factor is obtained from the lookup table. The result is multiplied by the compensation factor, thereby deriving the rotated coordinates.

d_{θ}_{ₗ}_{-θ}_{ₘ}_{,k} is used as the rotation symbol of the k^{th} iteration in the CORDIC algorithm. A CORDIC algorithm rotation θₗ+θₘ is carried out on (aₚ_{₁}_{q}_{₂}+aₚ_{₂}_{q}_{₁}, aₚ_{₁}_{q}_{₁}−aₚ_{₂}_{q}_{₂}). A compensation factor is obtained from the lookup table. The result is multiplied by the compensation factor, thereby deriving the rotated coordinates.

The elements of the non-diagonal processor are updated.

(5) Exchanging the elements between the processors: After the elements of the respective processors are updated, the matrix elements symmetric thereto are also updated to the same values. The updated elements are exchanged with the elements of other processors.

Then, the flow returns to Steps 2, 3, and 4 again for another round of computation and update. After three times of exchange, all the non-diagonal elements in the matrix have been updated once by the diagonal processors through Jacobi computing. Through multiple times of update, the non-diagonal elements in the matrix gradually converge to 0. The update ends after a predetermined convergence accuracy set by the user is met, and the parallel Jacobi computing ends.

The specific results are as follows:

First Round:

$${P}_{11} = ( \begin{matrix}237.4904 & 231.6229 \\ 231.6229 & 541.7360\end{matrix} ) , {P}_{22} = ( \begin{matrix}273.6585 & - 34.0290 \\ - 34.0290 & 170.5949\end{matrix} ) , {P}_{12} = ( \begin{matrix}- 104.5409 & 16.3696 \\ - 78.0729 & - 10.1869\end{matrix} ) ,$$

and the following is rendered after the update:

$${\overline{A}}_{1} = ( \begin{matrix}112.5 & 0 & - 58.0625 & 2.5625 \\ 0 & 666.75 & - 112.9375 & - 35.1875 \\ - 58.0625 & - 112.9375 & 283.875 & 0 \\ 2.5625 & - 35.1875 & 0 & 160.375\end{matrix} ) ,$$

and the following is rendered after the element exchange:

$${A}_{1} = ( \begin{matrix}112.5 & 2.5625 & 0 & - 58.0625 \\ 2.5625 & 160.375 & - 35.1875 & 0 \\ 0 & - 35.1875 & 666.75 & - 112.9375 \\ - 58.0625 & 0 & - 112.9375 & 283.875\end{matrix} ) .$$

Second Round:

$${P}_{11} = ( \begin{matrix}112.5 & 2.5625 \\ 2.5625 & 160.375\end{matrix} ) , {P}_{22} = ( \begin{matrix}666.75 & - 112.9375 \\ - 112.9375 & 283.875\end{matrix} ) , {P}_{12} = ( \begin{matrix}0 & - 58.0625 \\ - 35.1875 & 0\end{matrix} ) ,$$

and the following is rendered after the update:

$${\overline{A}}_{2} = ( \begin{matrix}112.375 & 0 & 17.125 & - 55.4375 \\ 0 & 160.5 & - 33.0625 & - 12.25 \\ 17.125 & - 33.0625 & 697.625 & 0 \\ - 55.4375 & - 12.25 & 0 & 253\end{matrix} ) ,$$

and the following is rendered after the element exchange:

$${A}_{2} = ( \begin{matrix}- 112.375 & - 55.4375 & 0 & 17.125 \\ - 55.4375 & 253 & - 12.25 & 0 \\ 0 & - 12.25 & 697.625 & - 33.0625 \\ 17.125 & 0 & - 33.0625 & 160.5\end{matrix} ) .$$

Eighth Round:

$${P}_{11} = ( \begin{matrix}92.5 & - 0.0625 \\ - 0.0625 & 700.1875\end{matrix} ) , {P}_{22} = ( \begin{matrix}273.5 & - 0.0625 \\ - 0.0625 & 157.3125\end{matrix} ) , {P}_{12} = ( \begin{matrix}0 & 0 \\ 0 & 0\end{matrix} ) ,$$

and the following is rendered after the update:

$${\overline{A}}_{8} = ( \begin{matrix}92.5 & 0 & 0 & 0 \\ 0 & 700.25 & 0 & 0 \\ 0 & 0 & 273.4375 & 0 \\ 0 & 0 & 0 & 157.3125\end{matrix} )$$

As shown above, the non-diagonal elements of the matrix has met the convergence condition (while parallel Jacobi computing is an algorithm that approximates the diagonal elements to 0, a fixed-point number with a limited number of bits is used in actual implementation to represent decimals, so even though the values of the non-diagonal elements may reach 0, errors are also introduced). At this time, the elements on the diagonal of Ā₈ are the eigenvalues that are obtained. By applying the obtained eigenvalues to a signal direction-of-arrival (DOA) estimation algorithm, as shown in the following diagram, the power spectrum function of a multiple signal classification (MUSIC) algorithm reaches the peak value at 0 degrees, which shows that the invention realizes a proper function.

In the embodiment, the performance of the invention in the actual application is demonstrated in two aspects, i.e., operation time, FPGA resource consumption.

Operation time: Since 16-bit fixed-point number is set for the data, the number of times of internal iterations is 16 in the CORDIC algorithm. Considering the result compensation, there are 17 FPGA clock cycles for the CORDIC algorithm cycle. Considering also that the elements need to be exchanged between steps of the parallel Jacobi, which takes one clock cycle, it takes a total of 18 clock cycles for the method of realizing the accelerated parallel Jacobi computing of the invention to realize one step of the parallel Jacobi. In the embodiment, the convergence condition is set as the absolute value of the maximum value of the non-diagonal elements in the covariance matrix being less than 0.001. The convergence condition is met after 8 iterations, which takes 144 clock cycles. The clock frequency used in the example is set as 250M, which takes 0.576 milliseconds.

Resource consumption: A Verilog program realizing the example is integrated on the Vivado 2017.1 software platform. The results shows that the example consumes 2360 lookup tables (LUTs) and 688 registers (REGs), which respectively takes up 0.54% and 0.79% of the total resources. According to the above, the design consumes only a limited amount of FPGA resources.

According to the conventional method for realizing parallel Jacobi, the diagonal processors require a CORDIC algorithm cycle to obtain rotation angles, and then require two successive CORDIC algorithms using the rotation angles obtained by the diagonal processors to update the elements of the diagonal processors. In other words, the conventional method requires a total of three CORDIC algorithm cycles. The non-diagonal processor needs to wait for the diagonal processor to obtain the rotation angle. Then, the non-diagonal processor also requires two consecutive CORDIC algorithms to update the elements of the non-diagonal processor. The angles of two rotations are respectively the rotation angle transmitted from the diagonal processor on the same row and the rotation angle transmitted from the diagonal processor on the same column. The respective processors operate in parallel, and it requires at least three CORDIC algorithm cycles to realize one step of parallel Jacobi. According to the CORDIC algorithm used in the invention, the operations are carried out in parallel and only require only one CORDIC algorithm cycle. The comparison between the invention and the conventional method in terms of the processes of the processors is as shown in Table 2.

TABLE 2
Comparison on Processes of Processors between the Invention and the
Conventional Parallel Jacobi Method

| | Conventional method | | Present invention | |
|---|---|---|---|---|
| | Diagonal | Non-diagonal | Diagonal | Non-diagonal |
| Time | processor | processor | processor | processor |
| First | Compute a | Wait | Compute a | Compute a symbol |
| CORDIC | rotation | | symbol set | set corresponding |
| algorithm | angle | | corresponding | to an angle sum |
| cycle | | | to a double | and an angle |
| | | | angle of the | difference of two |
| | | | rotation angle | rotation angles and |
| | | | and carry out | carry out a rotation |
| | | | a rotation | |
| Second | First | First rotation | | |
| CORDIC | rotation | | | |
| algorithm | | | | |
| cycle | | | | |
| Third | Second | Second | | |
| CORDIC | rotation | rotation | | |
| algorithm | | | | |
| cycle | | | | |

Based on the above, the invention significantly facilitates the speed of obtaining eigenvalues over the conventional method and is applicable when eigenvalue decomposition needs to be carried out quickly in actual processing.

The equivalent structural changes made by those skilled in the art based on the contents of the description and drawings of the invention shall be comprehensively covered in the scope of the invention.

1. A method of realizing accelerated parallel Jacobi computing for an FPGA, comprising:
step (1) initializing processors:
inputting data of a n×n-dimensional matrix into the FPGA and carrying out a rotation transformation process using the parallel Jacobi computing, wherein a CORDIC algorithm is adopted in the parallel Jacobi computing to carry out a planar rotation, and a two-dimensional X-Y coordinate system is established in the planar rotation,
a plurality of processors are provided in the FPGA, the processors are arranged in an array, each of the processors is connected with an adjacent processor via a data interface to exchange data and elements, and each element in the n×n-dimensional matrix for carrying out the parallel Jacobi computing is assigned to a processor if of the processors according to a formula as follows:
$${P}_{ij} = ( \begin{matrix}{a}_{2 i - 1 , 2 j - 1} & {a}_{2 i - 1 , 2 j} \\ {a}_{2 i , 2 j - 1} & {a}_{2 i , 2 j}\end{matrix} ) , i \leq j , j = 1 , 2 , … , \frac{n}{2} ,$$
wherein Pᵢⱼ represents the processor in an i^{th} row and a j^{th} column, a_{2i,2j} represents an element in a 2i^{th} row and a 2j^{th} column in the n×n-dimensional matrix, and n represents dimensionality of the n×n-dimensional matrix, and
the processor Pᵢⱼ whose subscripted symbol satisfies i=j is a diagonal processor and the processor Pᵢⱼ whose subscripted symbol does not satisfy i=j is a non-diagonal processor, and in the processor Pᵢⱼ an element whose subscripted symbol satisfies 2i=2j and 2i−1=2j−1 is a diagonal element, and an element whose subscripted symbol does not satisfy 2i=2j and 2i−1=2j−1 is a non-diagonal element;
step (2) computing a symbol set corresponding to a rotation angle 2θ by the diagonal processor and outputting the symbol set to the non-diagonal processor:
obtaining a symbol set {d_{2θ,k}}, k=1, 2, . . . , N, which corresponds to a rotation angle 2θ of the CORDIC algorithm, through iterations by using a formula as follows, wherein a total number of the iterations is the same as a total number of iterations of the CORDIC algorithm:
$$tan ( {θ}_{k} ) = \frac{{α}_{k}}{{β}_{k}} = tan ( {θ}_{k - 1} - {d}_{2 θ , k} {ϕ}_{k - 1} ) = \frac{{tanθ}_{k - 1} - {d}_{θ , k} {tanϕ}_{k - 1}}{1 + {d}_{θ , k} {tanθ}_{k - 1} {tanϕ}_{k - 1}} = \frac{{α}_{k - 1} {2}^{k - 1} - {d}_{θ , k} {β}_{k - 1}}{{β}_{k - 1} {2}^{k - 1} + {d}_{θ , k} {α}_{k - 1}} , \\ {d}_{2 θ , k} = \{ \begin{matrix}- 1 , & \frac{{α}_{k - 1}}{{β}_{k - 1}} < 0 \\ 1 , & \frac{{α}_{k - 1}}{{β}_{k - 1}} \geq 0\end{matrix} , \\ {θ}_{0} = 2 θ , \\ tan ( {ϕ}_{k - 1} ) = {2}^{- ( k - 1 )} , \\ k = 1 , 2 , … , N ,$$
wherein k represents an ordinal number of an iteration, N represents the total number of the iterations and is set as a data bit number adopted by the FPGA, αₖ represents a first symbol parameter of a k^{th} iteration, βₖ represents a second symbol parameter of the k^{th} iteration, θ₀ represents a rotation angle initial value, that is, 2θ, θₖ represents a residual rotation angle through k times of iterations, ϕₖ₋₁ represents an angle parameter of a (k−1)^{th} iteration, and d_{2θ,k} represents a symbol corresponding to the rotation angle 2θ at the k^{th} iteration, and
the diagonal processor outputs the rotation angle 2θ obtained through computing carried out by itself and the corresponding symbol set {d_{2θ,k}} to the non-diagonal processor on the same row and the non-diagonal processor on the same column;
step (3) updating elements of the diagonal processor:
carrying out the CORDIC algorithm on first to-be-rotated coordinates (2a_{pq},aₚₚ−a_{qq}) by using d_{2θ,k} obtained in each of the iterations in the step (2) as a rotation symbol of the k^{th} iteration in the CORDIC algorithm, so as to carry out a planar rotation by using the rotation angle 2θ;
after all the iterations in the step (2) are completed, multiplying a final planar rotation result by a first compensation factor to obtain rotated Y coordinates, that is, y₁=2a_{pq} sin 2θ+(aₚₚ−a_{qq}) cos 2θ, wherein the first compensation factor is obtained according to a formula as follows:
$${C}_{1} = {\prod }_{k = 1}^{N} cos ( {ϕ}_{k - 1} ) ,$$
wherein C₁ represents the first compensation factor;
updating diagonal elements in the diagonal processor by using a formula as follows, and setting non-diagonal elements to 0:
$${{a}^{′}}_{pp} = \frac{{a}_{qq} + {a}_{pp} + {y}_{1}}{2} , \\ {{a}^{′}}_{qq} = \frac{{a}_{qq} + {a}_{pp} - {y}_{1}}{2} ,$$
wherein a′ₚₚ, a′_{qq} represent two updated diagonal elements in the diagonal processor, y₁ represents a rotated Y-axis coordinate of the first to-be-rotated coordinates;
step (4) updating elements of the non-diagonal processor;
step (5) exchanging the elements between the processors;
step (6) updating the non-diagonal elements in all the diagonal processors in the n×n-dimensional matrix by the parallel Jacobi computing after the exchanging, returning to the step (2) for another round of processing and updating, repeating the updating until the non-diagonal elements in the n×n-dimensional matrix gradually converge to 0, finishing the updating when a predetermined convergence accuracy is met, and ending the parallel Jacobi computing.

2. The method of realizing the accelerated parallel Jacobi computing for the FPGA as claimed in claim 1, wherein in the step (2), an initial rotation angle corresponding to the non-diagonal elements in the diagonal processor when iterative computing starts is θ, and a computation is as follows:
$$tan ( 2 θ ) = \frac{{α}_{0}}{{β}_{0}} , \\ {α}_{0} = 2 {a}_{pq} , \\ {β}_{0} = {a}_{pp} - {a}_{qq} ,$$
wherein a_{pq}, a_{qp} respectively represent two non-diagonal elements initially included in the diagonal processor, a_{qp}=a_{pq}, aₚₚ and a_{qq} respectively represent diagonal elements initially included in the diagonal processing unit, α₀ represents an initial first symbol parameter, and β₀ represents an initial second symbol parameter.

3. The method of realizing the accelerated parallel Jacobi computing for the FPGA as claimed in claim 1, wherein the n×n-dimensional matrix is a covariance matrix of data collected by an antenna array or data before image dimensionality reduction, and is a real symmetric matrix.

4. The method of realizing the accelerated parallel Jacobi computing for the FPGA as claimed in claim 1, wherein in the step (1), if n in the n×n-dimensional matrix is an odd number, the n×n-dimensional matrix is expanded into a matrix with even-numbered dimensionality by adding a n+1^{th} column and a n+1^{th} row, and element values of the added n+1^{th} column and n+1^{th} row n+1^{th} are all set to 0.

5. The method of realizing the accelerated parallel Jacobi computing for the FPGA as claimed in claim 1, wherein the step (4) comprises:
step (4.1) receiving, by the non-diagonal processor Pᵢⱼ, symbol sets output from two diagonal processors Pᵢᵢ, Pⱼⱼ and represented as {d_{2θ}_{ᵢ}_{,k}}, {d_{2θ}_{ⱼ}_{,k}}, wherein d_{2θ}_{ᵢ}_{,k} and d_{2θ}_{ⱼ}_{,k} respectively represent symbols corresponding to a rotation angle 2θᵢ and a rotation angle 2θⱼ at the k^{th} iteration, and two symbols d_{θ}_{ᵢ}_{+θ}_{ⱼ}_{,k} and d_{θ}_{ᵢ}_{-θ}_{ⱼ}_{,k} are respectively computed by using formulae as follows to obtain two symbol sets {d_{θ}_{ᵢ}_{+θ}_{ⱼ}_{,k}} and {d_{θ}_{ᵢ}_{-θ}_{ⱼ}_{,k}}:
d_{θ}_{ᵢ}_{+θ}_{ⱼ}_{,k}=½(d_{2θ}_{ᵢ}_{,k}+d_{2θ}_{ⱼ}_{,k}), k=1,2, . . . ,N,
d_{θ}_{ᵢ}_{-θ}_{ⱼ}_{,k}=½(d_{2θ}_{ᵢ}_{,k}−d_{2θ}_{ⱼ}_{,k}), k=1,2, . . . ,N,
wherein d_{θ}_{ᵢ}_{+θ}_{ⱼ}_{,k} and d_{θ}_{ᵢ}_{-θ}_{ⱼ}_{,k} respectively represent symbols corresponding to a rotation angle θᵢ+θⱼ and a rotation angle θᵢ−θⱼ, and 2θᵢ and 2θⱼ respectively represent double angles of rotation angles corresponding to the non-diagonal elements of the two diagonal processors Pᵢᵢ and Pⱼⱼ;
step (4.2) computing values of a second compensation factor and a third compensation factor corresponding to all possible symbol combinations formed by first
$$⌈ \frac{N}{2} ⌉$$
symbols in the two symbol sets {d_{θ}_{ᵢ}_{+θ}_{ⱼ}_{,k}} and {d_{θ}_{ᵢ}_{-θ}_{ⱼ}_{,k}} by using formulae as follows, one symbol combination being formed by
$$⌈ \frac{N}{2} ⌉$$
symbols, so as to establish lookup table data by using the values of the second compensation factor and the third compensation factor corresponding to the respective, different symbol combinations, an absolute value of each symbol in the first
$$⌈ \frac{N}{2} ⌉$$
symbols serves as a lookup address, and a lookup table is generated by using a block memory (block random access memory), an address bit number of the lookup table is set as
$$⌈ \frac{N}{2} ⌉ ,$$
and a data depth is
$${2}^{⌈ \frac{N}{2} ⌉} :$$
$${C}_{2} = {\prod }_{k = 1}^{⌈ \frac{N}{2} ⌉} cos ( {d}_{{θ}_{i} - {θ}_{j} , k} {ϕ}_{k - 1} ) , {d}_{{θ}_{i} - {θ}_{j} , k} ∈ \{ - 1 , 0 , 1 \} , \\ {C}_{3} = {\prod }_{k = 1}^{⌈ \frac{N}{2} ⌉} cos ( {d}_{{θ}_{i} + {θ}_{j} , k} {ϕ}_{k - 1} ) , {d}_{{θ}_{i} + {θ}_{j} , k} ∈ \{ - 1 , 0 , 1 \} ,$$
wherein C₂ represents the second compensation factor, and C₃ represents the third compensation factor;
step (4.3) for the non-diagonal processor, representing four elements included in the non-diagonal processor as
$$( \begin{matrix}{a}_{{p}_{1} {q}_{1}} & {a}_{{p}_{1} {q}_{2}} \\ {a}_{{p}_{2} {q}_{1}} & {q}_{{p}_{2} {q}_{2}}\end{matrix} ) ,$$
using the obtained d_{θ}_{ᵢ}_{-θ}_{ⱼ}_{,k} as the rotation symbol of the k^{th} iteration in the CORDIC algorithm, carrying out the CORDIC algorithm on second to-be-rotated coordinates (aₚ_{₁}_{q}_{₁}+aₚ_{₂}_{q}_{₂}, aₚ_{₁}_{q}_{₂}−aₚ_{₂}_{q}_{₁}) to carry out the planar rotation by using the rotation angle θᵢ−θⱼ and multiplying a planar rotation result by the second compensation factor whose value is obtained by accessing the lookup table of the step (4.2) to obtain rotated coordinates represented as:
$$\{ \begin{matrix}{x}_{2} = ( {a}_{{p}_{1} {q}_{1}} + {a}_{{p}_{2} {q}_{2}} ) cos ( {θ}_{i} - {θ}_{j} ) - ( {a}_{{p}_{1} {q}_{2}} - {a}_{{p}_{2} {q}_{1}} ) sin ( {θ}_{i} - {θ}_{j} ) \\ {y}_{2} = ( {a}_{{p}_{1} {q}_{2}} - {a}_{{p}_{2} {q}_{1}} ) cos ( {θ}_{i} - {θ}_{j} ) + ( {a}_{{p}_{1} {q}_{1}} + {a}_{{p}_{2} {q}_{2}} ) sin ( {θ}_{i} - {θ}_{j} )\end{matrix} ,$$
wherein x₂ and y₂ respectively represent rotated coordinates of the second to-be-rotated coordinates;
using the obtained d_{θ}_{ᵢ}_{+θ}_{ⱼ}_{,k} as the rotation symbol of the k^{th} iteration in the CORDIC algorithm, carrying out the CORDIC algorithm on third to-be-rotated coordinates (aₚ_{₁}_{q}_{₂}+aₚ_{₂}_{q}_{₁},aₚ_{₁}_{q}_{₁}−aₚ_{₂}_{q}_{₂}) to carry out a planar rotation by using the rotation angle θᵢ+θⱼ, and multiplying a planar rotation result by the third compensation factor whose value is obtained by accessing the lookup table of the step (4.2) to obtain rotated coordinates represented as:
$$\{ \begin{matrix}{x}_{3} = ( {a}_{{p}_{1} {q}_{2}} + {a}_{{p}_{2} {q}_{1}} ) cos ( {θ}_{i} + {θ}_{j} ) - ( {a}_{{p}_{1} {q}_{1}} - {a}_{{p}_{2} {q}_{2}} ) sin ( {θ}_{i} + {θ}_{j} ) \\ {y}_{3} = ( {a}_{{p}_{1} {q}_{1}} - {a}_{{p}_{2} {q}_{2}} ) cos ( {θ}_{i} + {θ}_{j} ) + ( {a}_{{p}_{1} {q}_{2}} + {a}_{{p}_{2} {q}_{1}} ) sin ( {θ}_{i} + {θ}_{j} )\end{matrix} ,$$
wherein x₃ and y₃ respectively represent rotated coordinates of the third to-be-rotated coordinates; and
step (4.4) adopting formulae as follows to update the elements in the non-diagonal processor:
a′ₚ_{₁}_{q}_{₁}=½(x₂+y₃),
a′ₚ_{₁}_{q}_{₂}=½(x₃+y₂),
a′ₚ_{₂}_{q}_{₁}=½(x₃−y₂),
a′ₚ_{₂}_{q}_{₂}=½(x₂−y₃),
wherein a′ₚ_{₁}_{q}_{₁}, a′ₚ_{₁}_{q}_{₂}, a′ₚ_{₂}_{q}_{₁}, and a′ₚ_{₂}_{q}_{₂} respectively represent four elements included in the non-diagonal processor.

6. The method of realizing the accelerated parallel Jacobi computing for the FPGA as claimed in claim 1, wherein in the step (5), exchanging updated elements between the processors after the elements of each processor are updated, and the step (5) further comprises:
step (5.A) exchanging the diagonal elements in the diagonal processor, wherein it is assumed that a current diagonal processor Pᵢᵢ comprises a diagonal element aₚ_{ᵢ}ₚ_{ᵢ} and a diagonal element a_{q}_{ᵢ}_{q}_{ᵢ}, and, for the diagonal element aₚ_{ᵢ}ₚ_{ᵢ}, i represents a diagonal processor row/column ordinal number, if i=1, the diagonal element aₚ_{ᵢ}ₚ_{ᵢ} is not changed, if i=2, a value of the diagonal element aₚ_{ᵢ}ₚ_{ᵢ} is changed to a value of a diagonal element a_{q}_{_{i−1}}_{q}_{_{i−1}}, and if i>2, the value of the diagonal element aₚ_{ᵢ}ₚ_{ᵢ} is changed to a value aₚ_{_{i−1}}ₚ_{_{i−1}} of a diagonal element, and for the diagonal element a_{q}_{ᵢ}_{q}_{ᵢ}, if
$$i < \frac{n}{2} ,$$
a value of the diagonal element a_{q}_{ᵢ}_{q}_{ᵢ} is changed to a value of a_{q}_{ᵢ₊₁}_{q}_{ᵢ₊₁}, and if
$$i < \frac{n}{2} ,$$
the value of the diagonal element a_{q}_{ᵢ}_{q}_{ᵢ} is changed to the value of the diagonal element aₚ_{ᵢ}ₚ_{ᵢ}; and
step (5.B) exchanging the non-diagonal elements in the diagonal processor and elements in the non-diagonal processor by changing positions according to the following: positions of the non-diagonal elements in the diagonal processor and the elements in the non-diagonal processor are shifted, so that a subscripted row symbol of an element is the same as a row number of a diagonal element shifted to the same row after the exchanging of the step (5.A), and a subscripted column symbol of the element is the same as a column number of a diagonal element shifted to the same column after the exchanging of the step (5.A).

7. The method of realizing the accelerated parallel Jacobi computing for the FPGA as claimed in claim 1, wherein the steps (2), (3), and (4) are carried out simultaneously.
